(19) United States
(12) Patent Application Publication
(10) Pub. No.: US 2002/0026477 A1
(43) Pub. Date: Feb. 28, 2002

(54) System and method for automatically informing internet users of other users having similar interests in virtual space

(76) Inventor: Won Tai Choi, Yongin (KR)

Correspondence Address: Timothy J. Keefer, Wildman, Harrold, Allen & Dixon, 225 West Wacker Drive, Chicago, IL, 60606, US

(21) Appl. No.: 09/944,900

(22) Filed: Aug. 31, 2001

(30) Foreign Application Priority Data
Aug. 31, 2000 (KR) 2000-51106

(51) Int. Cl. G06F 15/16

(52) U.S. Cl. 709/204

(57) ABSTRACT

A system and a method automatically inform Internet users in a 3-D virtual reality environment of other users having similar interests by using the information of the users. The system for determining a second user who has similar interests with a first user's information in a virtual space includes a calculation part for calculating a similarity between the first user and the second user, and a determining part. The calculation part monitors whether there is the second user in a predetermined distance from the first user in the virtual space, and calculates an information similarity between the first and second users by using the users' information stored in a storage part of the is virtual space. The determining part determines whether the first user is similar to the second user or not.

### FIELD OF THE INVENTION

The present invention relates to a system and method for automatically informing Internet users in a 3-D virtual reality environment of other users having similar interests, by using user information obtained at the time the users signed for an Internet service.

### BACKGROUND OF THE INVENTION

Recently, a new technique for providing a 3-D virtual space on a computer screen was developed, allowing Internet users to navigate the virtual space in a 3-D environment when they search for a web site of interest.

However, in such a 3-D virtual space, personal information such as age, sex, occupation, and interest that are collected when users sign up for the 3-D reality service has been used only for managing the user database. This personal information has not been shared with other users for one reason or another.

Therefore, in order to one to find other people who are one or more of the same interests, one has to form a cyber community comprised of many users having similar interests, an association of like-minded persons or a meeting place, by directly communicating with other users. However, there is a limitation to finding the like-minded persons by only direct communication between users under conventional systems. For one, one has to spend time looking for a cyber community of his/her interest. Another user not belonging to a cyber community should send his/her E-mail message to other users in order to look for a likeminded user. In conclusion, a system and method to help users of a similar interest to easily find each other in a 3-D virtual space is desired to promote interaction among Internet users.

### SUMMARY OF THE INVENTION

It is, therefore, an objective of the present invention to provide a system and a method for automatically determining another user having similar interests with a predetermined user's information in a virtual space by using information of many registered users, and guiding the determined another user to a predetermined user.

In accordance with one aspect of the present invention, there is provided a system for automatically informing a first user in a virtual space of a second user having similar interests, which comprises: means for calculating a similarity between the first and second users, which monitors whether there is the second user in a predetermined distance from the first user in the virtual space, and calculates a similarity between the first user and the second user by using the users' information stored in a storage part of the virtual space; and means for determining whether or not the first user is similar to the second user based on the similarity or not. The system further comprises means for guiding information of the second user to the first user when it is determined that the first user is similar to the second user. The users' information is comprised of public information and confidential information, which are updated by a user's selection. Here, the similarity is calculated by using public information of the first user and the second user. The guiding means guides the second user to the first user in real time when the similarity between the second user and the first user is above a predetermined value. If there are at least two second users in the predetermined distance from the first user, the similarity is calculated in a predetermined order of said at least two second users. The calculating means and the determining means are performed by a proxy agent that performs a predetermined action on behalf of the first user while the first user navigates the virtual space. The proxy agent includes: a controller for controlling the public information of the first user from the storage part; a calculator for calculating the similarity on the basis of the public information and a predetermined similarity calculation algorithm; and a communication part for communicating with a proxy agent of the second user.

In accordance with another aspect of the present invention, there is provided a method for automatically informing a first user in a virtual space of a second user having similar interests, which comprises the steps of: monitoring whether there is the second user in a predetermined distance from the first user in the virtual space; calculating, if there is the second user in the predetermined distance from the first user, a similarity between the first user and the second user by using the users' information stored in a storage part of the virtual space; and determining whether the first user is similar to the second user on the basis of the similarity.

### BRIEF DESCRIPTIONS OF THE DRAWINGS

The above and other objects and features of the present invention will become apparent from the following description of preferred embodiments given in conjunction with the accompanying drawings, in which:

FIG. 1 is a block diagram of a system for determining/guiding a user of similar interests in a virtual space in accordance with a preferred embodiment of the present invention;

FIG. 2 is a schematic block diagram of proxy agents A and B included in a proxy agent manager 40 of FIG. 1:

FIG. 3 is an exemplary category item used when a user selects his/her interest information on a computer screen;

FIG. 4 illustrates an exemplary case in which a lower category item is set to each category item; and

FIG. 5 is a flowchart showing an operation of the system 100 for determining/guiding a user of similar interests.

### DETAILED DESCRIPTION OF THE PRESENT INVENTION

An embodiment of the present invention will now be described in details in reference to the accompanying drawings.

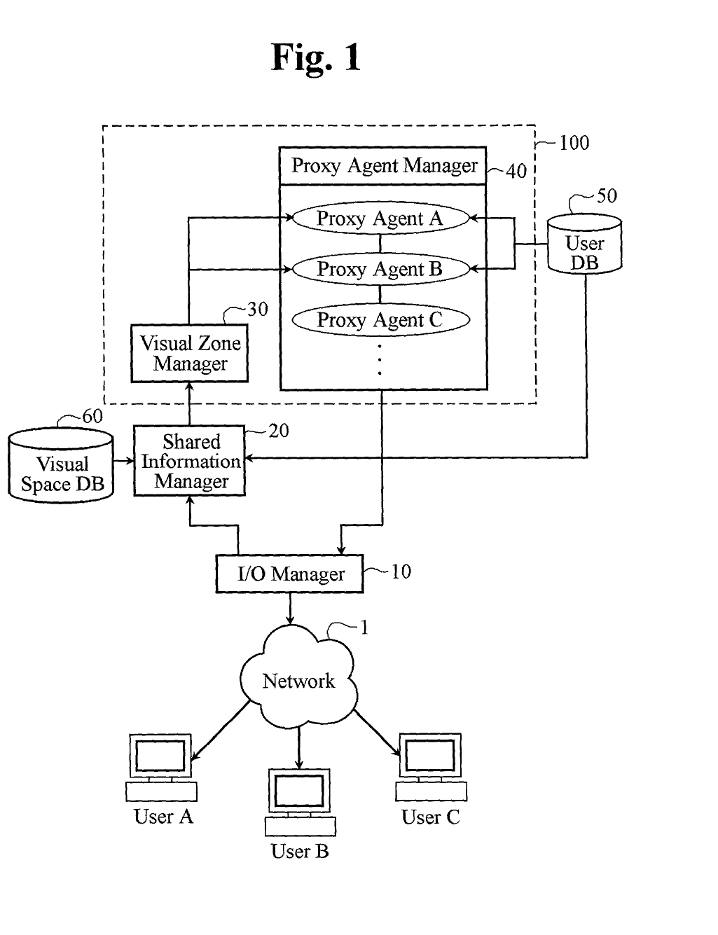

FIG. 1 is a block diagram of a system 100 for informing Internet users of the presence of other users having similar interests in accordance with a preferred embodiment of the present invention. First, the system 100 according to the present invention utilizes an Input/Output (I/O) manager 10, a shared information manager 20, a user database (DB) 50 and a virtual space DB 60, that are conventionally present at a server providing a 3-D virtual environment to Internet users.

The user DB 50 stores personal information that is collected when a user signs up for a 3-D virtual reality service. Some of personal information may be classified as confidential, only to be used by the operator of the virtual reality environment while the remaining information is classified as public. The user information stored in the user DB 50 should be periodically updated in order to reflect the latest interests of the users. The operator may ask the users if there have been any changes in the stored information at an annual membership renewal, for example.

The shared information manager 20 connected to the I/O manager 10, manages information that must be shared among many users existing in a same virtual space. For example, if three users A, B and C are present in the same space, the user A should be able to see the movement of users B and C. Likewise, users B and C should be able to observe user A. The shared information manager 20 automatically manages all the information needed to allow this mutual observation. Specifically, if users A, B and C log in at the I/O manager 10 through a network such as the Internet, the shared information manager 20 extracts the information of each user from the user DB 50, identifies what virtual reality environment the user has entered and determines the user's position and movement. Then it transmits all these shared information of each user to the visual zone manager 30.

In response, the visual zone manager 30 selects, for each user, those users present in the same virtual space who will be candidates for similarity test with respect to that particular user. The selected candidates are forwarded to the corresponding proxy agent for the particular user in the proxy agent manager 40. For example, for user A, the information of all the other users (users B and C) present in a virtual space is not needed. Instead, only those other users located within a reasonable distance of user A in the virtual reality environment will be selected as candidates. In other words, the visual zone manager 30 defines a spatial limitation, using the position of each user as reference such that only those other users visible to the particular user, i.e., within a “visual zone” of the user, would be selected. Specifically, the visual zone may be a logical distance from an avatar, representation of a user in virtual reality space. Another way to define the visual zone is a spherical space with the avatar at its center, the diameter of the sphere is such that the all the avatars in the sphere are visible to the avatar. The diameter may be adjusted to a certain numerical number proper to the size and characteristics of a different virtual space. This visual zone is a space in which avatars can recognize each other and communicate with each other. The proxy agent manager 40 automatically spawns a proxy agent for each user at the time a user logs in at the virtual space providing server. The proxy agent is an automated unit, from the perspective of computer programming, that is run performing a given task until the user logs out.

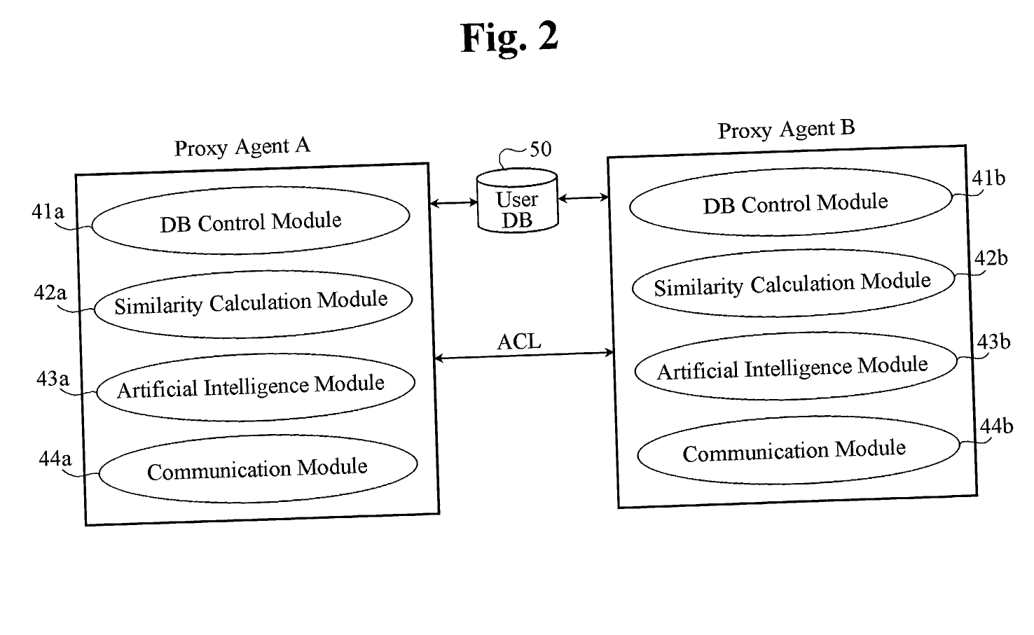

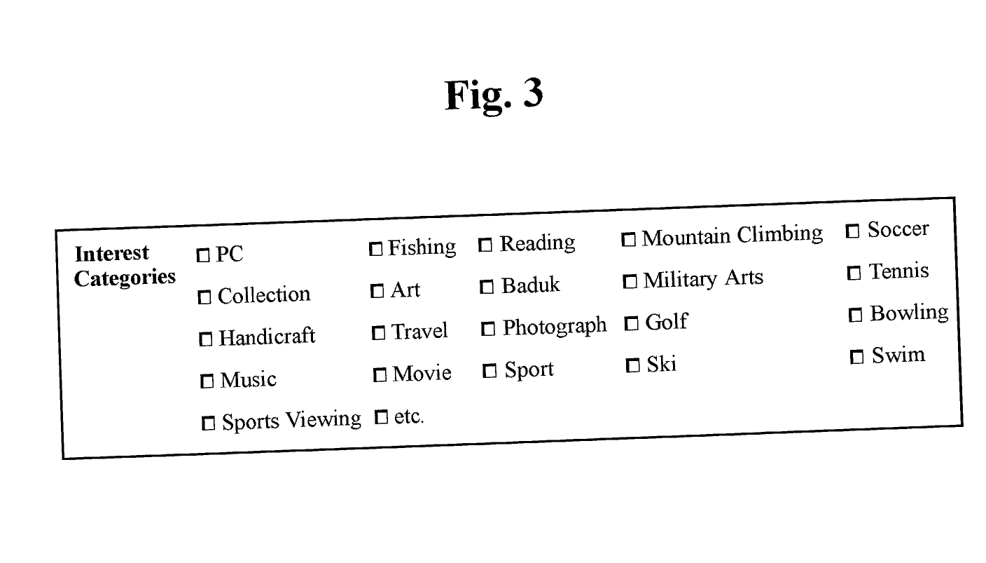

FIG. 2 is a block diagram of exemplary proxy agents A and B included in the proxy agent manager 40 of FIG. 1. Each agent is comprised of a database control module 41, a similarity calculation module 42, an artificial intelligence module 43, and a communication module 44. The DB control modules 41a and 41b control the public information of the users, which is a basis on which to determine whether the users have same interests. The similarity calculation modules 42a and 42b assign numerical measures to the similarity of the public information exchanged between proxy agents, using a similarity test algorithm to be described later. The artificial intelligence modules 43a and 43b help the proxy agents to communicate with each other. The communication modules 44a and 44b are used for communication between the proxy agents A and B. An algorithm for calculating similarity between users will be described with reference to FIG. 3 to FIG. 5. The public information of user entered by the users themselves is used as a basis for determining similarity between two users. A user, desiring interconnection with other users having the same interests, are prompted to enter his/her fields of interest when the user signs up to navigate the Internet in a 3-D environment.

FIG. 3 is an exemplary menu of interests having many categories that would be displayed on a computer screen. A user selects one or more categories.

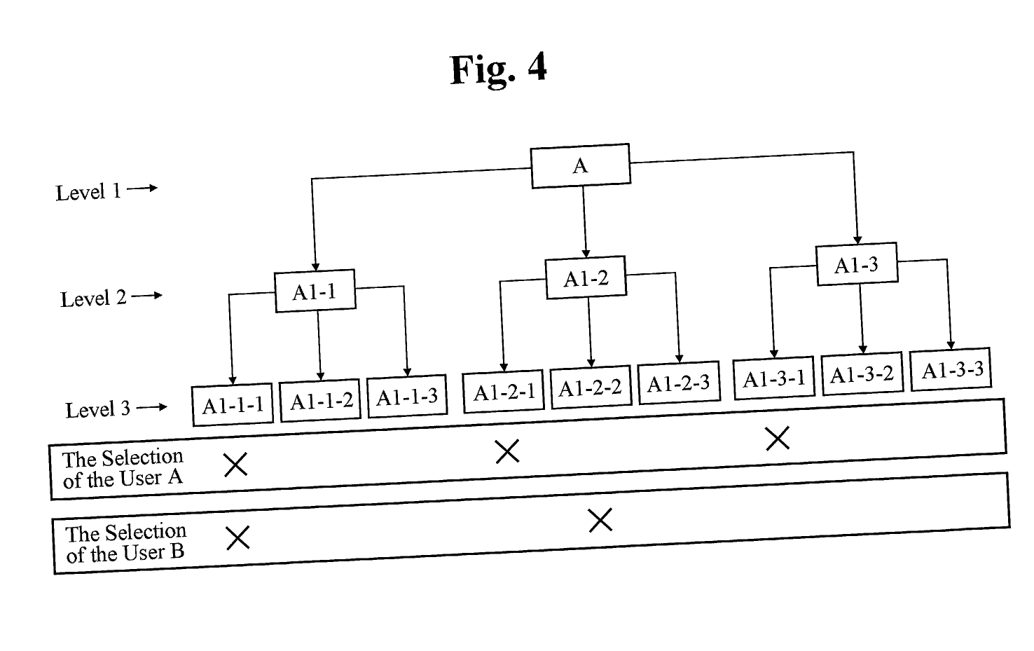

FIG. 4 illustrates successive subcategories of a main category. As shown in FIG. 4, three levels may be provided with each layer assigned a different weight. For instance, a value of 1 is assigned to the highest level, a value of 2 is given the second level, and a value of 3 is given the lowest level. Suppose that user A selected subcategories A1-1-1, A1-2-1 and A1-3-1 while user B selected A1-1-1, A1-2-2. Since the user A has more selections in this case, a proxy agent A may be a reference used for recommending other users having similar interests. That is, the proxy agent B representing the user B is introduced to the proxy agent A representing the user A, because the user A selects more selections than the user B. So, the proxy agent A is considered as an initiating agent. Such an initiating agent may be determined in accordance with a predetermined internal rule of the artificial intelligence modules 43a and 43b. Referring back to FIG. 4, users A and B have several same categories of interests, one at the lowest level, one at the intermediate level and on at the top level. The similarity measurement at the lowest level is 5 as the number of same interests, 1 in this case, is multiplied by the pre-assigned weight value of 5. Similarly, the similarity measurements at the mid-level and top level are 3 and 1, respectively. Thus, a similarity indicator with respect to the top category is 9. The total similarity between the two users is obtained by adding similarity indicators with respect to the remaining top categories. Other algorithm reflecting various needs of the user may be used. For instance, a user may designate his/her major field of interest special so that any other users who also have selected that field, even though the total similarity is not great, would be identified for him/her.

One possible situation is that user B is within the visible zone of user A while C is not. The zone manager 30 informs the proxy agent manager 40 that user B is a candidate for similarity test with respect to user A. In response, proxy agents A and B determine the degree of similarity of their interest, using the above algorithm, for example. When the similarity between the two users is above a predetermined threshold, then the presence of the user B is indicated to the user A, using any known message delivery techniques.

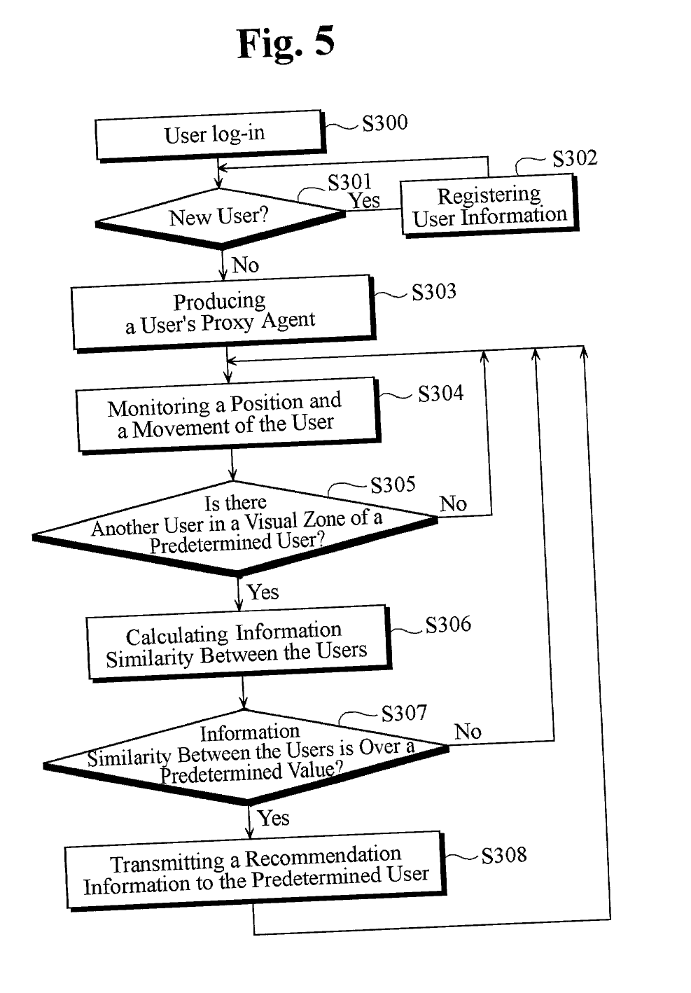

FIG. 5 is a flowchart showing the steps for determining users having similar interests and informing them of each other. If a user logs in for a service of 3-D virtual reality environment for navigating the Internet (S300), the server determines whether the user is a new user or not (S301). If the user is new, the user is prompted to register his/her personal information including field of interests, some of which may be classified confidential such that they would not be used for interest matching. The non-confidential information thus collected is stored in a user DB 50 (S302).

If the user is determined not new at the step S301, the proxy agent manager 40 produces a proxy agent for the user (S303). Then, a shared information manager 20 keep track of the position and movement in the virtual reality space of the user obtained from both the user DB 50 and the virtual space DB 60 (S304). In the meantime, the visual zone manager 30 determines (S305) in real time whether another users exist within a visual zone of the user inside the virtual reality environment. If there is no other user in the visual zone of the user, a program returns to the step S304.

Otherwise, the proxy agent of the user and the proxy agent of the other user calculate (S306) a degree of similarity between the two users based on the public information of the users that have been stored in the user DB 50.

Thereafter, if a similarity calculated by the step S306 is above a predetermined value (S307), a message is transmitted to the user, informing that the other user has one or more same interests via a network (S308), and a program returns to the step S304. If the similarity calculated by the step S306 is below the predetermined value (S307), a program returns to the step S304.

The above-described process for identifying other uses who have similar interest for a particular user in a virtual space can be performed in real time. For, although the pubic information of users is stored in the user DB 50, it is extracted only when necessary. Trying to find users having a same interest from all the users of the user DB 50 is impractical because of a heavy system load. In addition, the present invention first defines a visual zone of a particular user in the 3-D virtual reality environment before proceeding with identification of other users having the same interest as the particular user. Because the visual area normally coincide with a space where communication is possible between the users, a mutual communication can immediately begin as soon as they are informed of each other.

The present invention allows Internet users navigating the Internet in a 3-D browser environment to meet other users who registered one or more of same interests so that they can exchange information, because rather tedious efforts to look for those people on the network by users themselves would no longer needed.

While the present invention has been described and illustrated with respect to a preferred embodiment of the invention, it will be apparent to those skilled in the art that variations and modifications are possible without deviating from the broad principles and teachings of the present invention which should be limited solely by the scope of the claims appended hereto.

What is claimed is:

1. A system for automatically informing a first user in a virtual space of a second user having similar interests, the system comprising:
means for calculating a similarity between the first and second users, which monitors whether there is the second user in a predetermined distance from the first user in the virtual space, and calculates a similarity between the first user and the second user by using the users' information stored in a storage part of the virtual space; and
means for determining whether or not the first user is similar to the second user based on the similarity or not.

2. The system of claim 1, further comprising:
means for guiding information of the second user to the first user when it is determined that the first user is similar to the second user.

3. The system of claim 1, wherein the users' information is comprised of public information and confidential information, which are updated by a user's selection.

4. The system of claim 1, wherein the similarity is calculated by using public information of the first user and the second user.

5. The system of claim 2, wherein the guiding means guides the second user to the first user in real time when the similarity between the second user and the first user is above a predetermined value.

6. The system of claim 1, wherein, if there are at least two second users in the predetermined distance from the first user, the similarity is calculated in a predetermined order of said at least two second users.

7. The system of claim 1, wherein the calculating means and the determining means are performed by a proxy agent that performs a predetermined action on behalf of the first user while the first user navigates the virtual space.

8. The system of claim 7, wherein the proxy agent includes:
a controller for controlling the public information of the first user from the storage part;
a calculator for calculating the similarity on the basis of the public information and a predetermined similarity calculation algorithm; and
a communication part for communicating with a proxy agent of the second user.

9. A method for automatically informing a first user in a virtual space of a second user having similar interests, the method comprising the steps of:
monitoring whether there is the second user in a predetermined distance from the first user in the virtual space;
calculating, if there is the second user in the predetermined distance from the first user, a similarity between the first user and the second user by using the users' information stored in a storage part of the virtual space; and
determining whether the first user is similar to the second user on the basis of the similarity.

10. The method of claim 9, further comprising the step of:
guiding information of the second user to the first user when it is determined that the first user is similar to the second user.

11. The method of claim 9, wherein the user's information is comprised of public information and confidential information, which are updated by a selection of each user.

12. The method of claim 9, wherein the similarity is calculated by using public information of the first user and public information of the second user.

13. The method of claim 10, wherein the guiding step guides the second user to the first user in real time when the similarity between the first user and the second user is above a predetermined value.

14. The method of claim 9, wherein, if there are at least two second users in a predetermined distance from the first user, the calculating step sequentially calculates the similarity in a predetermined order of said at least two second users.

15. The method of claim 7, wherein the calculating step and the determining step are performed by a proxy agent that performs a predetermined action on behalf of the first user while the first user navigates the virtual space.
